(19) United States
(12) Patent Application Publication
(10) Pub. No.: US 2025/0357646 A1
(43) Pub. Date: Nov. 20, 2025

(54) SECONDARY BATTERY

(71) Applicant: MURATA MANUFACTURING CO., LTD., Kyoto (JP)

(72) Inventor: Hironobu KOBAYASHI, Kyoto (JP)

(21) Appl. No.: 19/285,015

(22) Filed: Jul. 30, 2025

Related U.S. Application Data
(63) Continuation of application No. PCT/JP2024/009655, filed on Mar. 12, 2024.

(30) Foreign Application Priority Data
Mar. 14, 2023 (JP) 2023-039998

(51) Int. Cl. H01M 50/557; H01M 50/538; H01M 50/566

(52) U.S. Cl. CPC H01M 50/557; H01M 50/538; H01M 50/566

(57) ABSTRACT

A secondary battery includes a plurality of current collectors electrically connected to a plurality of electrodes; and a terminal joined to the plurality of current collectors, wherein an outer surface of the terminal at a joint portion between the plurality of current collectors and the terminal has a first uneven region having an uneven shape, the first uneven region has a first uneven pattern having a plurality of first recessed portions; and two second uneven patterns each having a plurality of second recessed portions each having a larger area than an area of each of the first recessed portions in plan view of the outer surface of the terminal, and the first uneven pattern is located between the two second uneven patterns in the plan view.

### CROSS REFERENCE TO RELATED APPLICATIONS

The present application is a continuation of International Application No. PCT/JP2024/009655, filed on Mar. 12, 2024, which claims priority to Japanese Patent Application No. 2023-039998, filed on Mar. 14, 2023, the entire contents of which are incorporated herein by reference.

### BACKGROUND

The present disclosure relates to a secondary battery.

An ultrasonic joining device is disclosed including an anvil and a horn disposed to face the anvil. The ultrasonic joining device of Patent Document 1 ultrasonically joins a plurality of objects to be joined by pressurizing and vibrating the plurality of objects to be joined, which are disposed on the anvil in an overlapping manner with the horn.

In the ultrasonic joining device, a height of an outermost protruding portion among a plurality of protruding portions of at least one of the anvil and the horn is set to be smaller than a height of a protruding portion of an inner portion. As a result, in each of the objects to be joined, a crack is suppressed from occurring at a boundary between a gripping region sandwiched by the anvil and the horn and a non-gripping region not sandwiched by the anvil and the horn. Therefore, a strength of a joint portion of the objects to be joined is improved, and a joined state of the joint portion can be stabilized.

### SUMMARY

The present disclosure relates to a secondary battery.

However, in the ultrasonic joining device referenced in the Background section, when the height of the outermost protruding portion is smaller than the height of the protruding portion on the inner portion, the protruding portion on the inner portion wears earlier than the outermost protruding portion. As a result, when a difference between the height of the protruding portion on the inner portion and the height of the outermost protruding portion becomes small, there is a possibility that a crack occurs at the boundary between the gripping region and the non-gripping region, that the strength of the joint portion decreases, and that the joined state of the joint portion varies. The same applies to a case where the objects to be joined are a plurality of current collectors and terminals of the secondary battery.

The present disclosure has been made in view of the above, and relates to stabilizing a joined state between a plurality of current collectors and terminals in a secondary battery according to an embodiment.

A secondary battery of the present disclosure, in an embodiment, includes: a laminated body in which a plurality of electrodes are laminated; a plurality of current collectors electrically connected to the plurality of electrodes; and a terminal joined to the plurality of current collectors, wherein an outer surface of the terminal at a joint portion between the plurality of current collectors and the terminal has a first uneven region having an uneven shape, the first uneven region has: a first uneven pattern having a plurality of first recessed portions; and two second uneven patterns each having a plurality of second recessed portions each having a larger area than an area of each of the first recessed portions in plan view of the outer surface of the terminal, and the first uneven pattern is located between the two second uneven patterns in the plan view.

According to the secondary battery of the present disclosure, in an embodiment, the joined state between the plurality of current collectors and the terminal can be stabilized.

### BRIEF DESCRIPTION OF THE FIGURES

FIG. 1 is a plan view of a secondary battery according to an embodiment of the present disclosure.

FIG. 2 is a sectional view of the secondary battery taken along line II-II of FIG. 1.

FIG. 3 is a schematic view illustrating a process of joining a positive electrode terminal and a plurality of current collectors.

FIG. 4 is a plan view of a support surface of an anvil.

FIG. 5 is an arrow view of the anvil indicated by arrow V illustrated in FIG. 4.

FIG. 6 is a plan view of a pressing surface of a horn.

FIG. 7 is a side view of the horn.

FIG. 8 is a sectional view of the horn taken along line VIII-VIII illustrated in FIG. 6.

FIG. 9 is a sectional view of the horn taken along line IX-IX illustrated in FIG. 6.

FIG. 10 is a diagram illustrating a wear amount of the support surface in the anvil according to an embodiment of the present disclosure illustrated in FIG. 4 and a wear amount of a support surface in an anvil of a comparative example.

FIG. 11 is a plan view of a joint portion between the plurality of current collectors and the positive electrode terminal as viewed from a positive electrode terminal side.

FIG. 12 is an enlarged view of a part of a first uneven region illustrating a first uneven pattern illustrated in FIG. 11.

FIG. 13 is a sectional view of the joint portion.

FIG. 14 is an enlarged view of a part of the first uneven region illustrating the first uneven pattern, a second uneven pattern, and a third uneven pattern in FIG. 11.

FIG. 15 is a plan view of the joint portion between the plurality of current collectors and the positive electrode terminal as viewed from a current collector side.

FIG. 16 is an enlarged view of the second uneven region illustrated in FIG. 15.

FIG. 17 is a sectional view of the joint portion taken along line XVII-XVII illustrated in FIG. 16.

FIG. 18 is a sectional view of the joint portion taken along line XVIII-XVIII in FIG. 16.

FIG. 19 is a plan view of an anvil used in a joining process according an embodiment of the present disclosure.

FIG. 20 is an arrow view of the anvil indicated by arrow XX illustrated in FIG. 19.

FIG. 21 is a plan view of an anvil used in a joining process according to an embodiment of the present disclosure.

FIG. 22 is a plan view of an anvil used in a joining process according to an embodiment of the present disclosure.

FIG. 23 is a plan view of an anvil used in a joining process according to an embodiment of the present disclosure.

FIG. 24 is a plan view of an anvil used in a joining process according to an embodiment of the present disclosure.

FIG. 25 is a plan view of an anvil used in a joining process according to an embodiment of the present disclosure.

FIG. 26 is a side view of the anvil and a horn used in the joining process according to an embodiment of the present disclosure.

FIG. 27 is a plan view of an anvil used in a joining process according to an embodiment of the present disclosure.

FIG. 28 is a plan view of an anvil used in a joining process according to an embodiment of the present disclosure.

### DETAILED DESCRIPTION

Hereinafter, the present disclosure will be described in further detail including with reference to the drawings according to an embodiment. It is to be noted that the present disclosure is not limited thereto. Each of an embodiment is illustrative, and parts of the configurations illustrated in the different embodiments can be replaced or combined with each other.

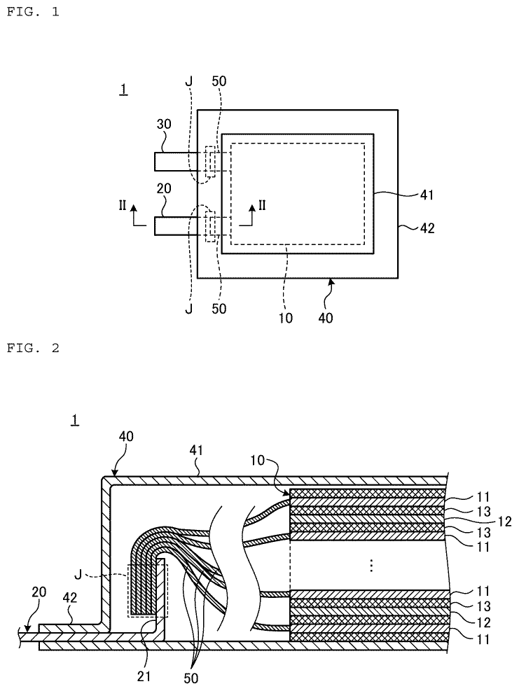

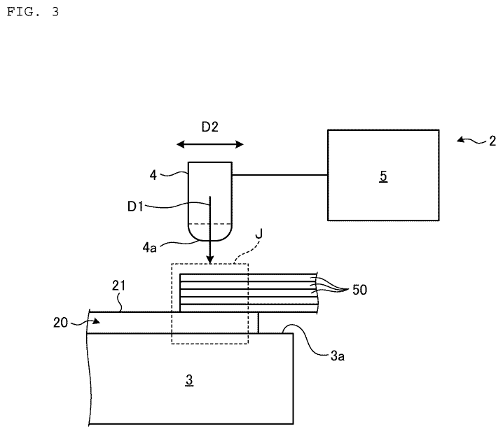

FIG. 1 is a plan view of a secondary battery 1 according to an embodiment of the present disclosure. FIG. 2 is a sectional view of the secondary battery 1 taken along line II-II of FIG. 1.

The secondary battery 1 is, for example, a lithium ion battery. As illustrated in FIG. 1, the secondary battery 1 includes a laminated body 10, a positive electrode terminal 20, a negative electrode terminal 30, an exterior body 40, and current collectors 50.

The laminated body 10 is accommodated in the exterior body 40. As illustrated in FIG. 2, the laminated body 10 has a laminated structure, and has a plurality of sheet-like positive electrodes 11 and a plurality of sheet-like negative electrodes 12, and the plurality of positive electrodes 11 and the plurality of negative electrodes 12 are alternately laminated with separators 13 interposed therebetween.

The positive electrode terminal 20 has a plate shape having an L-shaped section with a bent surface 21, and one end portion including the bent surface 21 is located inside the exterior body 40. Another end portion of the positive electrode terminal 20 is located outside the exterior body 40. Note that the positive electrode terminal 20 may have a plate shape that is not bent.

The positive electrode terminal 20 is electrically connected to the plurality of positive electrodes 11 via the plurality of current collectors 50, respectively. The current collectors 50 are each a metal foil. The positive electrode terminal 20 and the current collectors 50 connected to the positive electrode terminal 20 are formed of a same metal (for example, aluminum) as each other. The positive electrode terminal 20 and the plurality of current collectors 50 are electrically joined to form a joint portion J (details will be described later).

Similarly to the positive electrode terminal 20, the negative electrode terminal 30 has an L-shaped section with a bent surface, and one end portion including the bent surface is located inside the exterior body 40. Another end portion of the negative electrode terminal 30 is located outside the exterior body 40. The negative electrode terminal 30 is electrically connected to the plurality of negative electrodes 12 via the plurality of current collectors 50, respectively. The negative electrode terminal 30 and the current collectors 50 connected to the negative electrode terminal 30 are each formed of a same metal (for example, copper) as each other. The negative electrode terminal 30 and the plurality of current collectors 50 are electrically joined to form a joint portion J (details will be described later). Note that the negative electrode terminal 30 and the current collectors 50 connected to the negative electrode terminal 30 may be formed of different metals. For example, a material of the negative electrode terminal 30 may be copper, and a material of the current collectors 50 connected to the negative electrode terminal 30 may be nickel, nickel-plated copper, nickel-clad copper, or the like.

As illustrated in FIG. 1, the exterior body 40 has an accommodating portion 41 that accommodates the laminated body 10, and a flange portion 42 around the accommodating portion 41. In addition, an electrolyte (for example, a non-aqueous electrolytic solution) is accommodated in the accommodating portion 41.

The exterior body 40 is formed by folding one film. A part of the film is formed into a projected shape by, for example, press working to form the accommodating portion 41. The flange portion 42 is formed by joining portions where the films are overlapped around the accommodating portion 41, and leakage of the electrolyte is prevented.

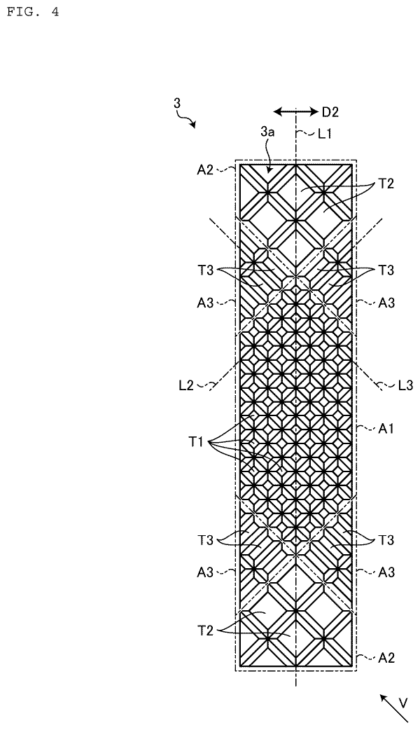

Next, the joint portion J between the positive electrode terminal 20 and the plurality of current collectors 50 will be described in detail. FIG. 3 is a schematic view illustrating a process of joining the positive electrode terminal 20 and the plurality of current collectors 50 to each other.

The positive electrode terminal 20 and the plurality of current collectors 50 are joined to each other using an ultrasonic joining machine 2. The ultrasonic joining machine 2 includes an anvil 3 having a support surface 3a that supports a workpiece, a horn 4 having a pressing surface 4a that presses the workpiece, and an ultrasonic vibration generator 5 that applies ultrasonic vibration to the horn 4. The horn 4 presses the positive electrode terminal 20 and the plurality of current collectors 50 in a pressing direction D1 along a thickness direction of the positive electrode terminal 20. The horn 4 vibrates along a vibration direction D2 orthogonal to the pressing direction D1.

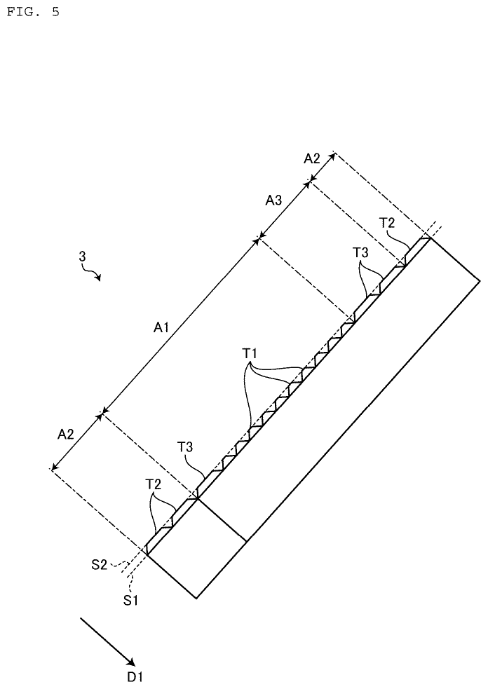

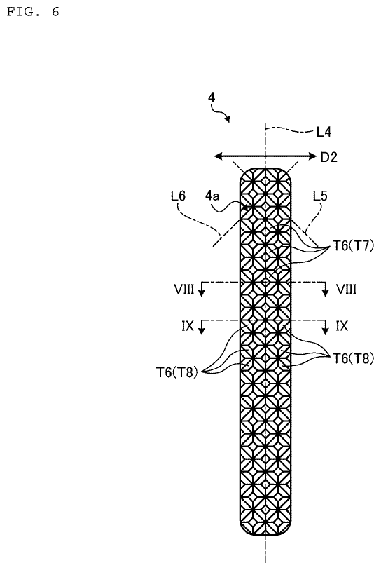

FIG. 4 is a plan view of the support surface 3a of the anvil 3. FIG. 5 is an arrow view of the anvil 3 indicated by arrow V illustrated in FIG. 4. Arrow V is along a third straight line L3 to be described later.

As illustrated in FIG. 4, the support surface 3a of the anvil 3 has a rectangular shape extending along a first straight line L1 orthogonal to the vibration direction D2 of the horn 4 in plan view. Note that the plan view of the support surface 3a is to view the support surface 3a along the pressing direction D1. In addition, a plurality of first protruding portions T1, a plurality of second protruding portions T2, and a plurality of third protruding portions T3 are disposed on the support surface 3a in a state where the support surface 3a has a line-symmetric shape with the first straight line L1 as a symmetry axis.

Each of the first protruding portions T1, the second protruding portions T2, and the third protruding portions T3 has a quadrangular frustum shape. That is, an upper surface and a lower surface of each of the first protruding portions T1, the second protruding portions T2, and the third protruding portions T3 are planar. Note that the first protruding portions T1, the second protruding portions T2, and the third protruding portions T3 overlapping a peripheral edge of the support surface 3a in plan view have shapes cut by the peripheral edge of the support surface 3a in plan view. Hereinafter, as for shapes of the first protruding portions T1, the second protruding portions T2, and the third protruding portions T3, shapes in a state where the first protruding portions T1, the second protruding portions T2, and the third protruding portions T3 are not cut by the peripheral edge of the support surface 3a2 will be described.

As illustrated in FIG. 5, the lower surfaces of the plurality of first protruding portions T1, the plurality of second protruding portions T2, and the plurality of third protruding portions T3 are located on a first plane S1 orthogonal to the pressing direction D1. The upper surfaces of the plurality of first protruding portions T1, the plurality of second protruding portions T2, and the plurality of third protruding portions T3 are located on a second plane S2 parallel to the first plane S1 (that is, on a same plane). That is, heights of the plurality of first protruding portions T1, the plurality of second protruding portions T2, and the plurality of third protruding portions T3 are equal to each other.

As illustrated in FIG. 4, a first range A1 in which the plurality of first protruding portions T1 are disposed is located at a central portion of the support surface 3a in a direction along the first straight line L1 in plan view. The lower surface and the upper surface of each of the first protruding portions T1 have a square shape in plan view. In addition, the plurality of first protruding portions T1 are disposed adjacent to each other in a state where diagonal lines are parallel to the first straight line L1. As a result, the plurality of first protruding portions T1 are located in a matrix along a second straight line L2 and the third straight line L3 intersecting the first straight line L1 in plan view.

In plan view, the second straight line L2 and the third straight line L3 are orthogonal to each other, and angles formed by the second straight line L2 and the third straight line L3, and the first straight line L1 are equal to each other and are 45°. Sides of the lower surface of the first protruding portion T1 are parallel to one of the second straight line L2 and the third straight line L3.

In addition, in the two first protruding portions T1 adjacent to each other, the sides of the lower surfaces are in contact with each other. That is, a section between the two first protruding portions T1 adjacent to each other has a V shape.

Second ranges A2 in each of which the plurality of second protruding portions T2 are disposed are disposed adjacent to the first range A1 on both outer sides of the first range A1 in a direction along the first straight line L1. In addition, each of the second ranges A2 is located, deviated from a range extending from the first range A1 along each of the second straight line L2 and the third straight line L3.

The lower surface and the upper surface of each of the second protruding portions T2 are square in plan view. In plan view, a length of sides on the lower surface of the second protruding portion T2 is longer than a length of the sides on the lower surface of the first protruding portion T1 (specifically, twice). That is, in plan view, an area of the lower surface of the second protruding portion T2 is larger than an area of the lower surface of the first protruding portion T1 (specifically, four times). In addition, in plan view, an area of the upper surface of the second protruding portion T2 is larger than an area of the upper surface of the first protruding portion T1.

In addition, the plurality of second protruding portions T2 are disposed adjacent to each other in a state where diagonal lines of the lower surfaces are parallel to the first straight line L1. As a result, the plurality of second protruding portions T2 are located in a matrix along the second straight line L2 and the third straight line L3 in plan view. The sides of the lower surface of the second protruding portion T2 are parallel to one of the second straight line L2 and the third straight line L3.

Furthermore, in the two second protruding portions T2 adjacent to each other, the sides of the lower surfaces are in contact with each other. That is, a section between the two second protruding portions T2 adjacent to each other has a V shape. In the second protruding portion T2 and the first protruding portion T1 adjacent to each other, vertexes of the lower surfaces are in contact with each other. That is, a section between the second protruding portion T2 and the first protruding portion T1 adjacent to each other has a V shape.

Third ranges A3 where the plurality of third protruding portions T3 are disposed are each located in a range extending from the first range A1 along each of the second straight line L2 and the third straight line L3. The plurality of third ranges A3 are each located between the first range A1 and the second range A2 in the direction along the first straight line L1. Each of the third ranges A3 is adjacent to the first range A1 in the direction along one of the second straight line L2 and the third straight line L3. In addition, the plurality of third ranges A3 are adjacent to the second ranges A2 in the direction along one of the second straight line L2 and the third straight line L3.

A lower surface and an upper surface of each of the third protruding portions T3 are rectangular in plan view. In plan view, an area of the upper surface of the third protruding portion T3 is larger than the area of the upper surface of the first protruding portion T1 and smaller than the area of the upper surface of the second protruding portion T2.

In addition, in long sides and short sides of the lower surface of the third protruding portion T3, a length of the long sides is equal to the length of one side of the lower surface of the second protruding portion T2, and a length of the short sides is equal to the length of one side of the lower surface of the first protruding portion T1. The plurality of third protruding portions T3 are disposed in a matrix along the second straight line L2 and the third straight line L3 in plan view. The sides of the lower surface of the third protruding portion T3 are parallel to one of the second straight line L2 and the third straight line L3.

Further, in the two third protruding portions T3 adjacent to each other, the sides of the lower surfaces are in contact with each other. That is, a section between the two third protruding portions T3 adjacent to each other has a V shape.

In addition, the third protruding portion T3 and the first protruding portion T1 adjacent to each other are adjacent to each other in the direction along one of the second straight line L2 and the third straight line L3, and the sides of the lower surfaces of the third protruding portion T3 and the first protruding portion T1 adjacent to each other are in contact with each other. That is, a section between the third protruding portion T3 and the first protruding portion T1 adjacent to each other has a V shape.

Further, the third protruding portion T3 and the second protruding portion T2 adjacent to each other are adjacent to each other in the direction along one of the second straight line L2 and the third straight line L3, and the sides of the lower surfaces of the third protruding portion T3 and the second protruding portion T2 adjacent to each other are in contact with each other. That is, a section between the third protruding portion T3 and the second protruding portion T2 adjacent to each other has a V-shape.

Inclination angles of side surfaces of the first protruding portion T1, the second protruding portion T2, and the third protruding portion T3 are equal to each other. On the support surface 3a having such a shape, a manufacturing process can be simplified. Specifically, the plurality of grooves each having a V-shaped section, which are provided between the first protruding portion T1, the second protruding portion T2, and the third protruding portion T3 and formed by the side surfaces of the first protruding portion T1, the second protruding portion T2, and the third protruding portion T3, are continuous from one side to another side of the support surface 3a in the direction along one of the second straight line L2 and the third straight line L3. Therefore, the plurality of first protruding portions T1, the plurality of second protruding portions T2, and the plurality of third protruding portions T3 can be easily formed by grinding the support surface 3a by moving a grindstone having a corner portion having a V-shaped section from the one side to the other side of the support surface 3a in the directions along the second straight line L2 and the third straight line L3.

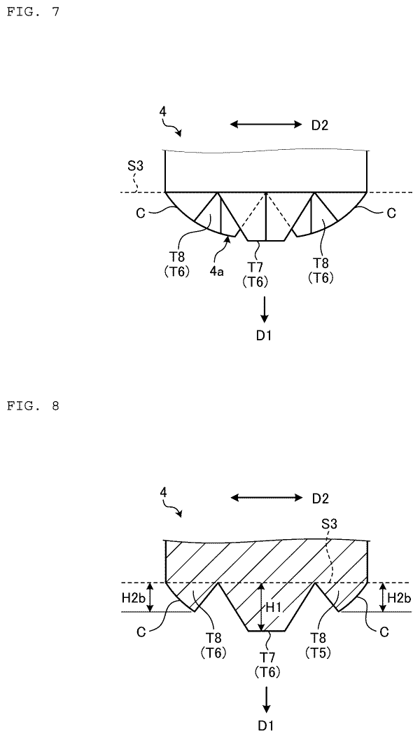

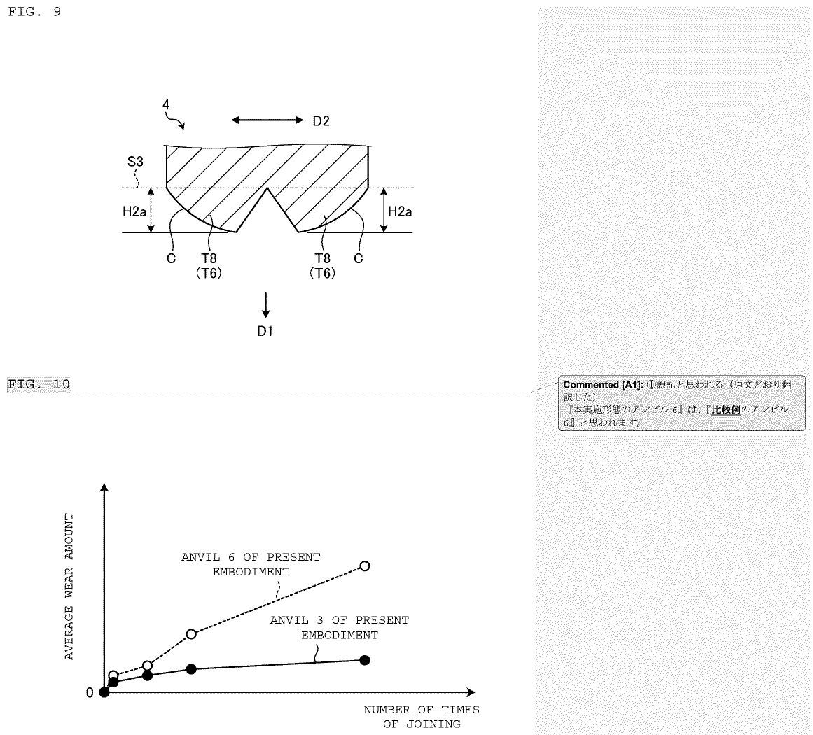

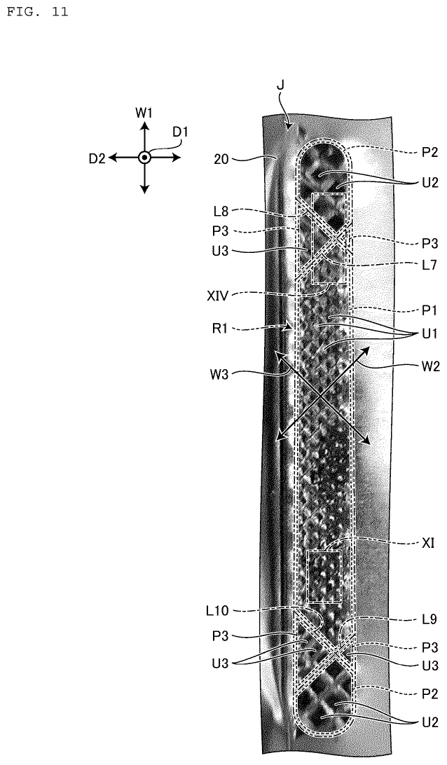

FIG. 6 is a plan view of the pressing surface 4a of the horn 4. FIG. 7 is a side view of the horn 4. FIG. 8 is a sectional view of the horn 4 taken along line VIII-VIII illustrated in FIG. 6. FIG. 9 is a sectional view of the horn 4 taken along line IX-IX illustrated in FIG. 6.

The pressing surface 4a of the horn 4 has a rectangular shape extending along a fourth straight line L4 orthogonal to the vibration direction D2 in plan view. Note that the plan view of the pressing surface 4a is to view the pressing surface 4a along the pressing direction D1. Corner portions of the pressing surface 4a are chamfered in plan view. In plan view, an area of the pressing surface 4a is smaller than an area of the support surface 3a.

A plurality of sixth protruding portions T6 are arranged on the pressing surface 4a in a state where the pressing surface 4a has a line-symmetric shape with the fourth straight line L4 as a symmetry axis. The plurality of sixth protruding portions T6 are located in a matrix along a fifth straight line L5 and a sixth straight line L6 intersecting the fourth straight line L4 in plan view.

In plan view, the fifth straight line L5 and the sixth straight line L6 are orthogonal to each other, and angles formed by the fifth straight line L5 and the sixth straight line L6, and the fourth straight line L4 are equal to each other and are 45°. Sides of a lower surface of each of the sixth protruding portions T6 are parallel to one of the fifth straight line L5 and the sixth straight line L6.

The sixth protruding portion T6 has a shape in which the lower surface is square and a width decreases toward a protrusion end. In addition, in the two sixth protruding portions T6 adjacent to each other, the sides of the lower surfaces are in contact with each other. As illustrated in FIGS. 7, 8, 9, the lower surfaces of the plurality of sixth protruding portions T6 are located on a third plane S3 orthogonal to the pressing direction D1.

In addition, as illustrated in FIG. 6, the plurality of sixth protruding portions T6 are disposed such that diagonal lines of the lower surfaces are parallel to the fourth straight line L4 in plan view. Hereinafter, among the plurality of sixth protruding portions T6, the sixth protruding portions T6 upper surfaces of which overlap the fourth straight line L4 in plan view are referred to as seventh protruding portions T7, and the sixth protruding portions T6 on both sides of the seventh protruding portions T7 in the vibration direction D2 are referred to as eighth protruding portions T8.

As illustrated in FIG. 7, the pressing surface 4a has an arc C that passes through a peripheral edge of the pressing surface 4a in the vibration direction D2 and is convex toward an outside of the horn 4 in a side view orthogonal to the vibration direction D2. The seventh protruding portions T7 do not overlap the arc C in side view. Each of the seventh protruding portions T7 has a truncated cone shape having quadrangular (specifically, square) upper surface and lower surface. As illustrated in FIGS. 7, 8, the upper surface and side surfaces of the seventh protruding portion T7 are linear in sectional view.

On the other hand, each of the eighth protruding portions T8 has an arc shape along the arc C in side view. That is, as illustrated in FIGS. 8, 9, an upper surface and side surfaces of the eighth protruding portion T8 are shaped along the arc C in sectional view. Specifically, the eighth protruding portion T8 has a shape in which an upper surface side is cut out from a same truncated cone shape as that of the seventh protruding portion T7 by a curved surface having the arc C in side view. Thus, heights H2a, H2b of the eighth protruding portion T8 are lower than a height H1 of the seventh protruding portion T7.

In the plurality of eighth protruding portions T8, the height of the eighth protruding portions T8 closer to the peripheral edge of the pressing surface 4a in the vibration direction D2 (in other words, it is away from a center in the vibration direction D2) becomes lower. Specifically, each of the eighth protruding portions T8 illustrated in FIG. 8 is closer to the peripheral edge of the pressing surface 4a in the vibration direction D2 than each of the eighth protruding portions T8 illustrated in FIG. 9, and the height H2b of the eighth protruding portion T8 illustrated in FIG. 8 is lower than the height H2a of the eighth protruding portion T8 illustrated in FIG. 9.

In addition, the height H1 of the seventh protruding portion T7 is higher than the heights of the first protruding portion T1, the second protruding portion T2, and the third protruding portion T3 of the anvil 3 (that is, a distance between the first plane S1 and the second plane S2).

Next, a process of joining the positive electrode terminal 20 and the plurality of current collectors 50 (hereinafter, referred to as a joining process) will be described. As illustrated in FIG. 3, the positive electrode terminal 20 is placed on the support surface 3a of the anvil 3 in a state where a surface of the positive electrode terminal 20 opposite to the bent surface 21 is in contact with the support surface 3a. Further, the plurality of current collectors 50 are disposed in a state of being overlapped on the bent surface 21 of the positive electrode terminal 20.

In addition, in plan view viewed along the pressing direction D1, the support surface 3a and the pressing surface 4a face each other in an overlapping state. At this time, in plan view viewed along the pressing direction D1, the first range A1, the second ranges A2, and the third ranges A3 of the support surface 3a overlap the plurality of sixth protruding portions T6 of the pressing surface 4a, respectively.

Subsequently, the plurality of current collectors 50 are pressed by the pressing surface 4a of the horn 4 along the pressing direction D1, and further, the horn 4 vibrates along the vibration direction D2, by which the positive electrode terminal 20 and the plurality of current collectors 50 are welded and integrated to form the joint portion J. Note that the negative electrode terminal 30 and the plurality of current collectors 50 are similarly joined using the ultrasonic joining machine 2 to form the joint portion J.

As described above, the horn 4 extends along the fourth straight line L4 orthogonal to the vibration direction D2. As a result, in both side portions of the horn 4 in the direction along the fourth straight line L4, the vibration of the horn 4 in the joining process is generated not only along the vibration direction D2 but also vibration along the pressing direction D1. Therefore, there is a possibility that on the support surface 3a of the anvil 3, a load acting on the support surface 3a in the joining process is larger in both side portions of the support surface 3a in the direction along the first straight line L1 than the central portion of the support surface 3a in the direction along the first straight line L1 orthogonal to the vibration direction D2, so that wear of the support surface 3a is increased.

In order to solve the problem of the wear of the support surface 3a, as described above, the plurality of first protruding portions T1 are located at the central portion of the support surface 3a in the direction along the first straight line L1, and the plurality of second protruding portions T2 are located at both end portions of the support surface 3a in the direction along the first straight line L1. In addition, in plan view, the area of the upper surface of the second protruding portion T2 is larger than the area of the upper surface of the first protruding portion T1. Therefore, at both the end portions of the support surface 3a in the direction along the first straight line L1, concentration of the load acting on the support surface 3a in the joining process is suppressed, and the wear of the support surface 3a can be suppressed.

Further, as described above, the heights of the plurality of first protruding portions T1, the plurality of second protruding portions T2, and the plurality of third protruding portions T3 are equal to each other. Thus, it is possible to suppress concentration of the load acting on the plurality of first protruding portions T1, the plurality of second protruding portions T2, and the plurality of third protruding portions T3. Therefore, wear amounts of the plurality of first protruding portions T1, the plurality of second protruding portions T2, and the plurality of third protruding portions T3 can be made uniform.

As described above, the wear of the support surface 3a can be suppressed at both the end portions of the support surface 3a in the direction along the first straight line L1, and the wear amounts of the plurality of first protruding portions T1, the plurality of second protruding portions T2, and the plurality of third protruding portions T3 can be made uniform. Therefore, the joined state between the plurality of current collectors 50 and the positive electrode terminal 20 can be stabilized in the joint portion J.

FIG. 10 is a diagram illustrating a wear amount of the support surface 3a in the anvil 3 according to an embodiment of the present disclosure illustrated in FIG. 4 and a wear amount of a support surface in an anvil 6 of a comparative example. In FIG. 10, a vertical axis represents an average wear amount of each of the protruding portions T1, T2, T3, and a horizontal axis represents a number of times of joining (so-called number of shots) of the current collector 50 and the positive electrode terminal 20.

The anvil 6 of the comparative example is different from the anvil 3 of the above embodiment in that the entire support surface is formed by the first protruding portions T1. That is, the first protruding portions T1 are disposed on the entire support surface of the anvil 6 of the comparative example.

As illustrated in FIG. 10, the average wear amount of the support surface 3a in the anvil 3 of the present embodiment is smaller than the average wear amount of the support surface in the anvil 6 of the comparative example. In addition, as the number of times of joining increases, the difference between the average wear amount of the support surface 3a in the anvil 3 of the present embodiment and the average wear amount of the support surface in the anvil 6 of the comparative example increases. That is, FIG. 10 illustrates that the wear of the support surface 3a is suppressed at both the ends of the support surface 3a in the direction along the first straight line L1 as described above, and the wear amounts of the plurality of first protruding portions T1, the plurality of second protruding portions T2, and the plurality of third protruding portions T3 are made uniform, so that the average wear amount of the support surface 3a in the anvil 3 of the present embodiment is suppressed.

Next, a state of an outer surface of the joint portion J between the positive electrode terminal 20 and the plurality of current collectors 50 will be described in detail.

FIG. 11 is a plan view of the joint portion J between the plurality of current collectors 50 and the positive electrode terminal 20 as viewed from a positive electrode terminal 20 side. The plan view of the joint portion J illustrated in FIG. 11 is a view illustrating the plan view of the joint portion J when the joint portion J is viewed from the positive electrode terminal 20 side along the thickness direction of the positive electrode terminal 20. The plan view of the joint portion J means that the joint portion J is viewed along the thickness direction of the positive electrode terminal 20.

An outer surface of the positive electrode terminal 20 in the joint portion J has a first uneven region R1 having an uneven shape having a plurality of recesses recessed in the thickness direction of the positive electrode terminal 20. A two-dot chain line illustrated in FIG. 11 indicates a peripheral edge of the first uneven region R1. The first uneven region R1 is formed by pressing the current collectors 50 along the pressing direction D1 by the horn 4 in a state where the positive electrode terminal 20 is supported on the support surface 3a of the anvil 3.

The first uneven region R1 extends along a first direction W1. In a state where the joint portion J is supported by the anvil 3 at the time of joining, the first direction W1 is substantially orthogonal to each of the pressing direction D1 and the vibration direction D2. The first uneven region R1 includes a first uneven pattern P1, two second uneven patterns P2, and four third uneven patterns P3. A seventh straight line L7, an eighth straight line L8, a ninth straight line L9, and a tenth straight line L10 illustrated in FIG. 11 indicate boundary lines of the first uneven pattern P1, the second uneven patterns P2, and the third uneven patterns P3 (details will be described later).

The first uneven pattern P1 is located in a central portion of the first uneven region R1 in the first direction W1. The first uneven pattern P1 is between the two second uneven patterns P2 in plan view. Specifically, the first uneven pattern P1 is between the two second uneven patterns P2 in the first direction W1. The first uneven pattern P1 has a plurality of first recessed portions U1.

Note that for the first recessed portions U1, and second recessed portions U2 and third recessed portions U3 to be described later, the first recessed portions U1, the second recessed portions U2, and the third recessed portions U3 overlapping a peripheral edge of the first uneven region R1 in plan view have shapes cut by the peripheral edge of the first uneven region R1 in plan view. Hereinafter, as for shapes of each of the first recessed portions U1, each of the second recessed portions U2, and each of the third recessed portions U3, shapes in a state where the first recessed portion U1, the second recessed portion U2, and the third recessed portion U3 are not cut by the peripheral edge of the first uneven region R1 will be described.

The plurality of first recessed portions U1 are arranged in a matrix along a second direction W2 and a third direction W3 intersecting each other in plan view. In the present embodiment, the second direction W2 and the third direction W3 are orthogonal to each other in plan view. The second direction W2 and the third direction W3 intersect the first direction W1.

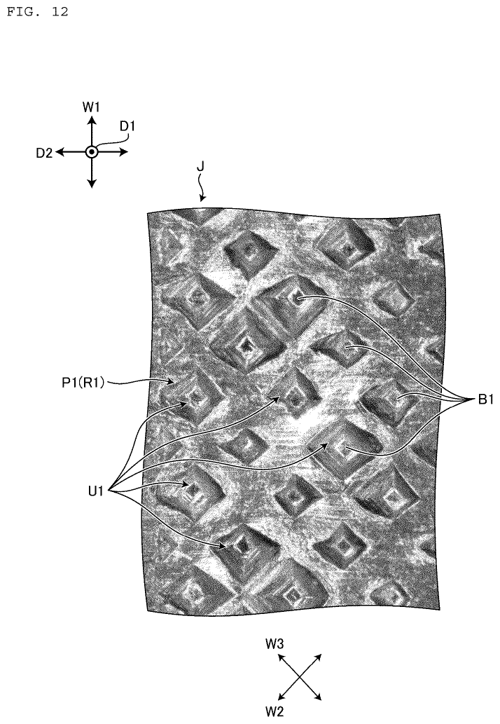

FIG. 12 is an enlarged view of a part of the first uneven region R1 illustrating the first uneven pattern P1 illustrated in FIG. 11. FIG. 12 is an enlarged view of a range indicated by a rectangular frame XI illustrated in FIG. 11. A bottom B1 of each of the first recessed portions U1 corresponds to the shape of the upper surface of the first protruding portion T1 of the support surface 3a. Specifically, the bottom B1 of the first recessed portion U1 has a planar shape and a square shape in plan view. Note that in the present specification, the planar shape refers to a range having a predetermined surface roughness or less, which is sufficiently smaller than a step between the bottom B1 and a peripheral edge of the bottom B1 of the first recessed portion U1 in the pressing direction D1. The sufficiently smaller predetermined surface roughness is 1/10 or less of the step between the bottom B1 and the peripheral edge of the bottom B1 of the first recessed portion U1 in the pressing direction D1. The surface roughness can be measured by measuring and analyzing a three-dimensional shape of a surface of the bottom B1 using a non-contact type surface roughness measuring device such as a laser microscope. In the non-contact type surface roughness measuring device, a magnification is set to 200 times, and a measurement range having a diameter of 0.05 mm in the vicinity of a center of the bottom B1 of the first recessed portion D1 is set to obtain the surface roughness. For example, when a measured roughness Ry (μm) is 20 (μm) or less, it can be determined that the bottom B1 is planar. Note that the roughness Ry is a maximum height defined in JIS B 0601(1994) JIS B 0031 (1994). In each of the second direction W2 and the third direction W3, an interval between the bottoms B1 of the two first recessed portions U1 adjacent to each other (specifically, a distance between center points of the bottoms B1 of the first recessed portions U1 in plan view) is equal to each other.

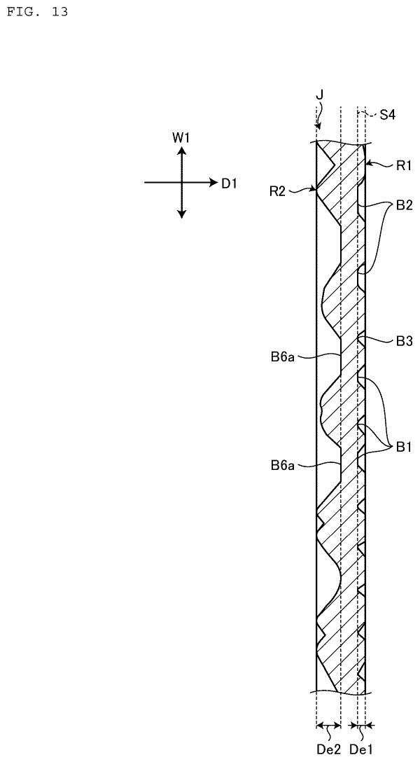

FIG. 13 is a sectional view of the joint portion J. Since the upper surfaces of the plurality of first protruding portions T1 are located on the same plane as described above, the bottoms B1 of the plurality of first recessed portions U1 are located on a fourth plane S4 (that is, on the same plane).

As illustrated in FIG. 11, the second uneven patterns P2 are located adjacent to the first uneven pattern P1 on both outer sides of the first uneven pattern P1 in the first direction W1. In addition, each of the second uneven patterns P2 is located at a position deviated from a range extending from the first uneven pattern P1 along the second direction W2 and the third direction W3 in plan view. The second uneven pattern P2 has the plurality of second recessed portions U2.

The plurality of second recessed portions U2 are arranged along one of the second direction W2 and the third direction W3 in plan view. In the present embodiment, the plurality of second recessed portions U2 are arranged in a matrix along the second direction W2 and the third direction W3 in plan view. In plan view, an area of each of the second recessed portions U2 is larger than the area of each of the first recessed portions U1.

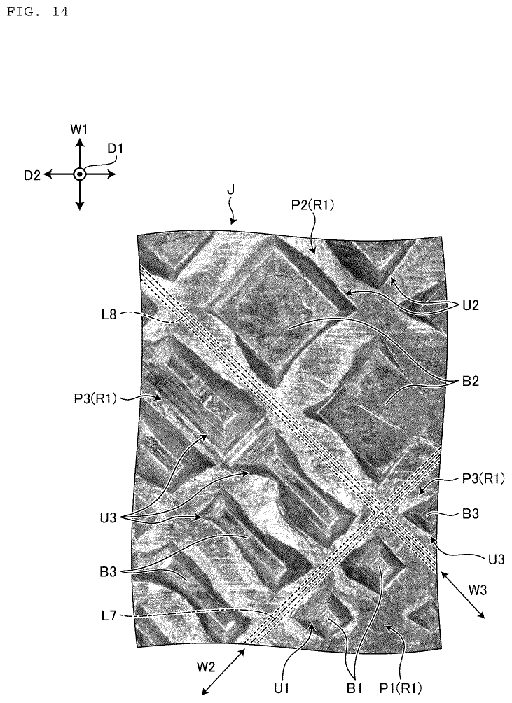

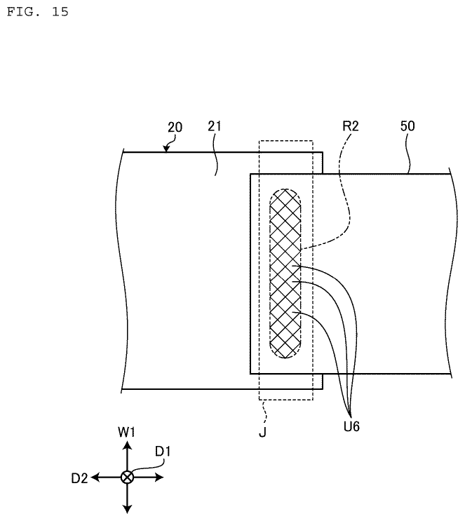

FIG. 14 is an enlarged view of a part of the first uneven region R1 illustrating the first uneven pattern P1, the second uneven pattern P2, and the third uneven patterns P3 in FIG. 11.

FIG. 14 is an enlarged view of a range indicated by a rectangular frame XIV illustrated in FIG. 11. A bottom B2 of the second recessed portion U2 corresponds to the shape of the upper surface of the second protruding portion T2 of the support surface 3a. Specifically, the bottom B2 of the second recessed portion U2 has a planar shape and a square shape in plan view. In addition, an area of the bottom B2 of the second recessed portion U2 is larger than an area of the bottom B1 of the first recessed portion U1. Further, in the first direction W1, a length of the bottom B2 of the second recessed portion U2 is longer than a length of the bottom B1 of the first recessed portion U1.

In each of the second direction W2 and the third direction W3, an interval between the bottoms B2 of the two second recessed portions U2 adjacent to each other (specifically, a distance between center points of the bottoms B2 of the second recessed portions U2 in plan view) is equal to each other. In addition, in each of the second direction W2 and the third direction W3, the interval between the bottoms B2 of the two second recessed portions U2 adjacent to each other is larger than the interval between the bottoms B1 of the two first recessed portions U1 adjacent to each other.

As illustrated in FIG. 13, the bottoms B2 of the plurality of second recessed portions U2 are located on the fourth plane S4 (that is, on the same plane), similarly to the bottoms B1 of the plurality of first recessed portions U1. Since the upper surfaces of the plurality of first protruding portions T1 and the upper surfaces of the plurality of second protruding portions T2 are located on the same plane as described above, the bottoms B1 of the plurality of first recessed portions U1 and the bottoms B2 of the plurality of second recessed portions U2 are located on the same plane.

As illustrated in FIG. 11, each of the third uneven patterns P3 is located in a range extending from the first uneven pattern P1 along each of the second direction W2 and the third direction W3. The third uneven pattern P3 is located between the first uneven pattern P1 and the second uneven pattern P2 in the first direction W1. The third uneven pattern P3 is adjacent to the first uneven pattern P1 in one of the second direction W2 and the third direction W3. In addition, the third uneven pattern P3 is adjacent to the second uneven pattern P2 in one of the second direction W2 and the third direction W3. The third uneven pattern P3 has the plurality of third recessed portions U3.

The plurality of third recessed portions U3 are arranged along at least one of the second direction W2 and the third direction W3 in plan view. In plan view, an area of each of the third recessed portions U3 is larger than the area of each of the first recessed portions U1 and is smaller than the area of each of the second recessed portions U2.

A bottom B3 of the third recessed portion U3 illustrated in FIG. 14 corresponds to the shape of the upper surface of the third protruding portion T3 of the support surface 3a. Specifically, the bottom B3 of the third recessed portion U3 has a planar shape and a rectangular shape in plan view. In addition, an area of the bottom B3 of the third recessed portion U3 is larger than the area of the bottom B1 of the first recessed portion U1 and is smaller than the area of the bottom B2 of the second recessed portion U2.

An interval between the bottoms B3 of the two third recessed portions U3 adjacent to each other in the second direction W2 (specifically, a distance between center points of the bottoms B3 of the third recessed portions U3 in plan view) and an interval between the bottoms B3 of the two third recessed portions U3 adjacent to each other in the third direction W3 are different from each other.

Specifically, for the third uneven patterns P3 adjacent to the first uneven patterns P1 in the second direction W2, the interval between the bottoms B3 of the two third recessed portions U3 adjacent to each other in the second direction W2 is equal to the interval between the bottoms B2 of the two second recessed portions U2 adjacent to each other in the second direction W2 and the third direction W3, and the interval between the bottoms B3 of the two third recessed portions U3 adjacent to each other in the third direction W3 is equal to the interval between the bottoms B1 of the two first recessed portions U1 adjacent to each other in the second direction W2 and the third direction W3.

In addition, for the third uneven patterns P3 adjacent to the first uneven patterns P1 in the third direction W3, the interval between the bottoms B3 of the two third recessed portions U3 adjacent to each other in the second direction W2 is equal to the interval between the bottoms B1 of the two first recessed portions U1 adjacent to each other in the second direction W2 and the third direction W3, and the interval between the bottoms B3 of the two third recessed portions U3 adjacent to each other in the third direction W3 is equal to the interval between the bottoms B1 of the two first recessed portions U1 adjacent to each other in the second direction W2 and the third direction W3.

As illustrated in FIG. 13, the bottoms B3 of the plurality of third recessed portions U3 are located on the fourth plane S4 (that is, on the same plane), similarly to the bottoms B1 of the plurality of first recessed portions U1 and the bottoms B2 of the plurality of second recessed portions U2. As described above, since the upper surfaces of the plurality of first protruding portions T1, the upper surfaces of the plurality of second protruding portions T2, and the upper surfaces of the plurality of third protruding portions T3 are located on the same plane, the bottoms B1 of the plurality of first recessed portions U1, the bottoms B2 of the plurality of second recessed portions U2, and the bottoms B3 of the plurality of third recessed portions U3 are located on the same plane.

Note that the seventh straight line L7 and the ninth straight line L9 are parallel to the second direction W2. In addition, the seventh straight line L7 and the ninth straight line L9 pass between the first recessed portions U1 and the third recessed portions U3 and between the third recessed portions U3 and the second recessed portions U2 adjacent to each other in the third direction W3. The eighth straight line L8 and the tenth straight line L10 are parallel to the third direction W3. In addition, the eighth straight line L8 and the tenth straight line L10 pass between the first recessed portions U1 and the third recessed portions U3 and between the third recessed portions U3 and the second recessed portions U2 adjacent to each other in the second direction W2. That is, the seventh straight line L7, the eighth straight line L8, the ninth straight line L9, and the tenth straight line L10 indicate ridgelines of the first uneven patterns P1, the second uneven patterns P2, and the third uneven patterns P3 adjacent to each other (details will be described later).

In addition, ranges of the first uneven pattern P1, the second uneven patterns P2, and the third uneven patterns P3 can be determined by drawing the peripheral edge of the first uneven region R1, the seventh straight line L7, the eighth straight line L8, the ninth straight line L9, and the tenth straight line L10 on an image of the outer surface of the joint portion J at a magnification of, for example, 100 times. In addition, the distance between the center points of the bottoms B1 of the first recessed portions U1, the distance between the center points of the bottoms B2 of the second recessed portions U2, the distance between the center points of the bottoms B3 of the third recessed portions U3, the area of the first recessed portion U1, the area of the second recessed portion U2, the area of the third recessed portion U3, the area of the bottom B1 of the first recessed portion U1, the area of the bottom B2 of the second recessed portion U2, and the area of the bottom B3 of the third recessed portion U3 can also be measured using the image of the outer surface of the joint portion J at the enlargement magnification of, for example, 100 times.

As described above, in the joining process, in both the side portions of the horn 4 in the first direction W1 orthogonal to the vibration direction D2 as with the first straight line L1, the vibration of the horn 4 in the joining process is generated not only along the vibration direction D2 but also along the pressing direction D1. Therefore, a load acting on the first uneven region R1 in the joining process increases in both the side portions of the first uneven region R1 in the first direction W1 as compared to the central portion of the first uneven region R1 in the first direction W1, and there is a possibility that a crack occurs in the joint portion J.

In order to solve the problem related to the crack of the joint portion J, as described above, the plurality of first recessed portions U1 are located at the central portion of the first uneven region R1 in the first direction W1, and the plurality of second recessed portions U2 are located at both the end portions of the first uneven region R1 in the first direction W1. In addition, in plan view, the area of the second recessed portion U2 is larger than the area of the first recessed portion U1. Therefore, at both the end portions of the first uneven region R1 in the first direction W1, the concentration of the load acting on the joint portion J in the joining process is suppressed.

In addition, the plurality of second recessed portions U2 are located at both the end portions of the first uneven region R1 in the first direction W1, the area of the second recessed portion U2 is larger than the area of the first recessed portion U1, so that the joint portion J is prevented from being locally compressed at both the end portions of the first uneven region R1. Therefore, the occurrence of the crack in the joint portion J can be suppressed, and the joined state between the plurality of current collectors 50 and the positive electrode terminal 20 can be stabilized in the joint portion J.

Further, as described above, the bottoms B1 of the plurality of first recessed portions U1, the bottoms B2 of the plurality of second recessed portions U2, and the bottoms B3 of the plurality of third recessed portions U3 are located on the same plane. Therefore, as compared with a case where the bottoms B1 of the plurality of first recessed portions U1, the bottoms B2 of the plurality of second recessed portions U2, and the bottoms B3 of the plurality of third recessed portions U3 are located on mutually different planes, local compression of the joint portion J is suppressed. Therefore, the occurrence of the crack in the joint portion J can be suppressed, and the joined state between the plurality of current collectors 50 and the positive electrode terminal 20 can be stabilized in the joint portion J.

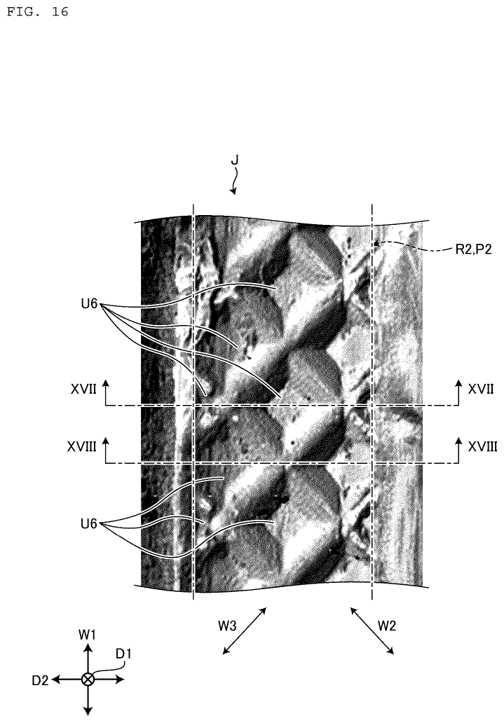

FIG. 15 is a plan view of the joint portion J between the plurality of current collectors 50 and the positive electrode terminal 20 as viewed from a current collector 50 side. In other words, the plan view of the joint portion J illustrated in FIG. 15 is a view illustrating the plan view of the joint portion J when the joint portion J is viewed from the current collector 50 side along the thickness direction of the positive electrode terminal 20.

An outer surface of the current collectors 50 at the joint portion J has a second uneven region R2 having an uneven shape and having a plurality of recesses recessed in the thickness direction of the positive electrode terminal 20. The second uneven region R2 is formed by pressing the current collectors 50 along the pressing direction D1 by the horn 4 in the state where the positive electrode terminal 20 is supported on the support surface 3a of the anvil 3. The second uneven region R2 extends along the first direction W1. The second uneven region R2 has a plurality of sixth recessed portions U6.

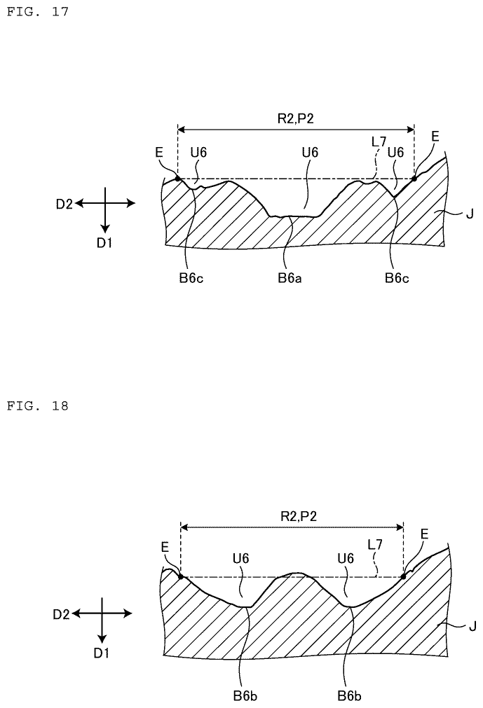

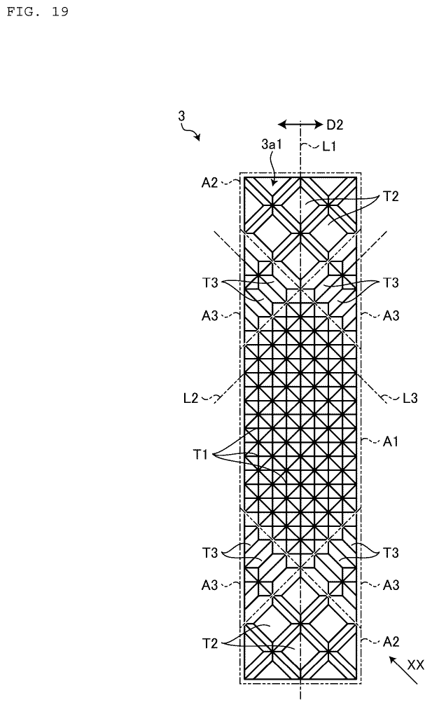

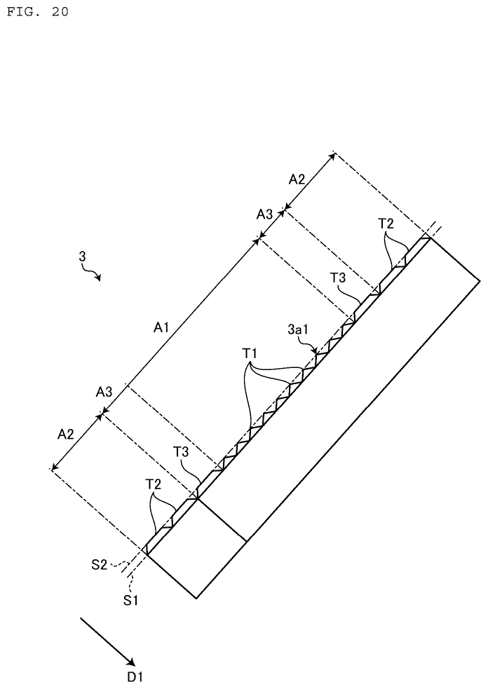

FIG. 16 is an enlarged view of the second uneven region R2 illustrated in FIG. 15. FIG. 17 is a sectional view of the joint portion J taken along line XVII-XVII in FIG. 16. FIG. 18 is a sectional view of the joint portion J taken along line XVIII-XVIII in FIG. 16.

The plurality of sixth recessed portions U6 correspond to the shape of the sixth protruding portions T6 (the seventh protruding portions T7 and the eighth protruding portions T8: see FIGS. 7, 8, 9) of the pressing surface 4a. Specifically, the sixth recessed portions U6 at a central portion of the second uneven region R2 in the vibration direction D2 correspond to the shape of the seventh protruding portions T7 of the horn 4. In addition, the sixth recessed portions U6 in both side portions of the second uneven region R2 in the vibration direction D2 correspond to the shape of the eighth protruding portions T8. As illustrated in FIG. 16, the plurality of sixth recessed portions U6 are located in a matrix along the second direction W2 and the third direction W3.

As described above, the heights of the eighth protruding portions T8 of the horn 4 are lower than the height of the seventh protruding portions T7. In addition, a depth of each of the sixth recessed portions U6 decreases as approaching a peripheral edge of the second uneven region R2 in the vibration direction D2. Therefore, as illustrated in FIGS. 17, 18, when a seventh straight line L7 connecting peripheral edges E of the second uneven region R2 in both side portions in the vibration direction D2 is used as a reference, a depth of a bottom B6a of each of the sixth recessed portions U6 at a central portion in the vibration direction D2 among the plurality of sixth recessed portions U6 is largest. The depth of the bottom of each of the sixth recessed portions U6 decreases as approaching each of the peripheral edges E of the second uneven region R2 in the vibration direction D2.

Specifically, in the plurality of sixth recessed portions U6 illustrated in FIGS. 17, 18, the bottom Boa of the sixth recessed portion U6 at the central portion in the vibration direction D2 illustrated in FIG. 17, bottoms B6b of the sixth recessed portions U6 outside the center in the vibration direction D2 illustrated in FIG. 18, and bottoms B6c of the sixth recessed portions U6 outside the center in the vibration direction D2 illustrated in FIG. 17 becomes closer to the peripheral edges E of the second uneven region R2 in the vibration direction D2 in this order. The depth of the bottom B6a, the depth of each of the bottoms B6b, and the depth of each of the bottoms B6c become smaller in this order.

As a result, a compressibility of the joint portion J at the bottoms of the sixth recessed portions U6 decreases toward each of the peripheral edges E of the second uneven region R2 in the vibration direction D2. That is, in the joining process, the current collectors 50 are prevented from being damaged at a peripheral edge portion of the second uneven region R2 in the vibration direction D2. Therefore, the joined state between the plurality of current collectors 50 and the positive electrode terminal 20 can be stabilized.

As described above, the eighth protruding portion T8 of the horn 4 has an arc shape along the arc C passing through the peripheral edge of the pressing surface 4a in the vibration direction D2 in sectional view. Therefore, as illustrated in FIGS. 17, 18, in the sixth recessed portion U6 located outside the center in the vibration direction D2 and extending along the peripheral edge E of the second uneven region R2, an outer surface connecting the peripheral edge E and the bottom of the second uneven region R2 has an arcuate section substantially along the arc C.

As a result, in the sixth recessed portions U6 on the peripheral edge of the second uneven region R2 in the vibration direction D2, the compressibility of the joint portion J decreases from the bottoms toward the peripheral edges E of the second uneven region R2. That is, in the joining process, the current collectors 50 are prevented from being damaged at the peripheral edges of the second uneven region R2 in the vibration direction D2. Therefore, the joined state between the plurality of current collectors 50 and the positive electrode terminal 20 can be stabilized.

In addition, as described above, the upper surface of the seventh protruding portion T7 of the horn 4 is planar. Therefore, the bottom Boa of the sixth recessed portion U6 at the central portion in the vibration direction D2 illustrated in FIG. 16 is planar.

As a result, a portion of the joint portion J having a high compressibility at the central portion in the vibration direction D2 is compressed in a planar shape, so that damage of the current collectors 50 is suppressed. Therefore, the joined state between the plurality of current collectors 50 and the positive electrode terminal 20 can be stabilized.

As described above, the height H1 of the seventh protruding portion T7 corresponding to the second uneven region R2 is higher than each of the heights of the first protruding portion T1, the second protruding portion T2, and the third protruding portion T3 corresponding to the first uneven region R1. As a result, as illustrated in FIG. 13. A depth De1 corresponding to the depth of the first recessed portion U1, the depth of the second recessed portion U2, and the depth of the third recessed portion U3 in the first uneven region R1 is smaller than a depth De2 corresponding to a depth of the deepest portion (that is, the bottom B6a) of the sixth recessed portion U6 in the second uneven region R2. That is, the depth of the first uneven region R1 is smaller than the depth of the second uneven region R2. As a result, the compressibility of the joint portion J on the positive electrode terminal 20 side becomes lower than the compressibility of the joint portion J on the current collector 50 side. Therefore, the occurrence of the crack in the joint portion J on the positive electrode terminal 20 side can be suppressed, and the joined state between the plurality of current collectors 50 and the positive electrode terminal 20 can be stabilized in the joint portion J.

Note that joining between the plurality of current collectors 50 and the negative electrode terminal 30 is performed in the same manner as the joining between the plurality of current collectors 50 and the positive electrode terminal 20. That is, a first uneven region R1 and a second uneven region R2 are formed in a joint portion J between the plurality of current collectors 50 and the negative electrode terminal 30 similarly to the joint portion J between the plurality of current collectors 50 and the positive electrode terminal 20. Therefore, the joint portion J between the plurality of current collectors 50 and the negative electrode terminal 30 can stabilize a joined state between the plurality of current collectors 50 and the negative electrode terminal 30 similarly to the joint portion J between the plurality of current collectors 50 and the positive electrode terminal 20.

Next, with respect to a joint portion J according to a first modification of an embodiment of the present disclosure, points different from the joint portion J according to the above-described embodiment will be mainly described.

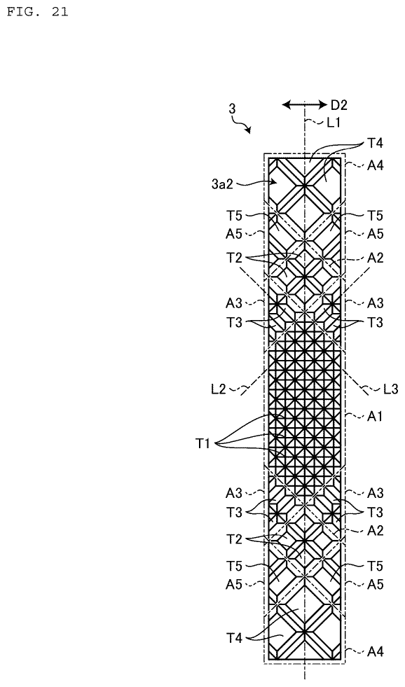

FIG. 19 is a plan view of an anvil 3 used in a joining process according to the first modification of an embodiment of the present disclosure. FIG. 20 is an arrow view of the anvil 3 indicated by arrow XX illustrated in FIG. 19. Arrow XX is along the third direction W3.

In a support surface 3a1 of the anvil 3 according to the first modification, a plurality of first protruding portions T1 each have a quadrangular frustum shape. A plurality of third protruding portions T3 each have a triangular section with a quadrangular lower surface. Note that a plurality of second protruding portions T2 each have a truncated quadrangular frustum shape similarly to the second protruding portions T2 of the above embodiment.

By performing the joining process using the above-described anvil 3, a bottom B1 of a first recessed portion U1, a bottom B2 of a second recessed portion U2, and a bottom B3 of a third recessed portion U3 included in the first uneven region R1 of the joint portion J have shapes below. That is, the bottom B1 of the first recessed portion U1 corresponding to the shape of the first protruding portion T1 has a V-shaped section. A bottom B3 of the third recessed portion U3 corresponding to the shape of the third protruding portion T3 has a V-shaped section. Note that the bottom B2 of the second recessed portion U2 corresponding to the shape of the second protruding portion T2 has a planar shape and has a square shape in plan view, similarly to the bottom B2 of the second recessed portion U2 of the above-described embodiment.

Next, with respect to a joint portion J according to a second modification of an embodiment of the present disclosure, points different from the joint portion J according to the first modification of the above-described embodiment will be mainly described. FIG. 21 is a plan view of an anvil 3 used in a joining process according to the second modification of an embodiment of the present disclosure.

A support surface 3a2 of the anvil 3 according to the second modification further includes a plurality of fourth protruding portions T4 and a plurality of fifth protruding portions T5 in addition to a plurality of first protruding portions T1, a plurality of second protruding portions T2, and a plurality of third protruding portions T3. Note that the fourth protruding portions T4 and the fifth protruding portions T5 overlapping peripheral edges of the support surface 3a2 in plan view have shapes cut by the peripheral edges of the support surface 3a2 in plan view. Hereinafter, as for shapes of each of the fourth protruding portions T4 and each of the fifth protruding portions T5, a shape in a state where the fourth protruding portion T4 and the fifth protruding portion T5 are not cut by the peripheral edges of the support surface 3a2 will be described.

Fourth ranges A4 where the plurality of fourth protruding portions T4 are disposed are each disposed adjacent to corresponding one of the second ranges A2 on both outer sides of the two second ranges A2 in the direction along the first straight line L1. In addition, each of the fourth ranges A4 is located at a position deviated from the direction extending from each of the second ranges A2 along each of the second straight line L2 and the third straight line L3.

The plurality of fourth protruding portions T4 each have a quadrangular frustum shape. That is, an upper surface and a lower surface of each of the fourth protruding portions T4 are planar. The lower surface and the upper surface of the fourth protruding portion T4 are square in plan view. In plan view, a length of sides on the lower surface of the fourth protruding portion T4 is longer than a length of sides on a lower surface of each of the second protruding portions T2 (specifically, twice). That is, in plan view, an area of the lower surface of the fourth protruding portion T4 is larger than an area of the lower surface of the second protruding portion T2 (specifically, four times). In addition, in plan view, an area of the upper surface of the fourth protruding portion T4 is larger than an area of an upper surface of the second protruding portion T2.

In addition, the plurality of fourth protruding portions T4 are disposed adjacent to each other in a state where diagonal lines of the lower surfaces are parallel to the first straight line L1. As a result, the plurality of fourth protruding portions T4 are located in a matrix along the second straight line L2 and the third straight line L3 in plan view. Sides of the lower surfaces of the plurality of fourth protruding portions T4 are parallel to one of the second straight line L2 and the third straight line L3.

Further, in the two fourth protruding portions T4 adjacent to each other, the sides of the lower surfaces are in contact with each other. That is, a section between the two second protruding portions T2 adjacent to each other has a V shape. Vertexes of the lower surfaces of the fourth protruding portion T4 and the second protruding portion T2 adjacent to each other are in contact with each other. That is, a section between the fourth protruding portion T4 and the second protruding portion T2 adjacent to each other has a V shape.

Fifth ranges A5 in which the plurality of fifth protruding portions T5 are disposed are each adjacent to corresponding one of the second ranges A2 in the direction along each of the second straight line L2 and the third straight line L3. The fifth ranges A5 are each adjacent to corresponding one of the fourth ranges A4 in the direction along each of the second straight line L2 and the third straight line L3.

The plurality of fifth protruding portions T5 each have a triangular section with a quadrangular lower surface. A lower surface and an upper surface of each of the fifth protruding portions T5 are rectangular in plan view. In plan view, an area of the upper surface of the fifth protruding portion T5 is larger than the area of the upper surface of the second protruding portion T2 and smaller than the area of the upper surface of the fourth protruding portion T4.

In addition, in long sides and short sides of the lower surface of the fifth protruding portion T5, a length of the long sides is equal to the length of one side of the lower surface of the fourth protruding portion T4, and a length of the short sides is equal to the length of one side of the lower surface of the second protruding portion T2. The plurality of fifth protruding portions T5 are disposed along one of the second straight line L2 and the third straight line L3 in plan view. The sides of the lower surfaces of the plurality of third protruding portions T3 are parallel to one of the second straight line L2 and the third straight line L3. Note that the plurality of fifth protruding portions T5 may be disposed in a matrix along the second straight line L2 and the third straight line L3 in plan view.

Further, in the two fifth protruding portions T5 adjacent to each other, the sides of the lower surfaces are in contact with each other. That is, a section between the two fifth protruding portions T5 adjacent to each other has a V shape.

In addition, the fifth protruding portion T5 and the fifth protruding portion T5 adjacent to each other are adjacent to each other in the direction along one of the second straight line L2 and the third straight line L3, and the sides of the lower surfaces of the fifth protruding portion T5 and the fifth protruding portion T5 adjacent to each other are in contact with each other. That is, a section between the fifth protruding portion T5 and the fifth protruding portion T5 adjacent to each other has a V shape.

Further, the fifth protruding portion T5 and the fourth protruding portion T4 adjacent to each other are adjacent to each other in the direction along one of the second straight line L2 and the third straight line L3, and the sides of the lower surfaces of the fifth protruding portion T5 and the fourth protruding portion T4 adjacent to each other are in contact with each other. That is, a section between the fifth protruding portion T5 and the fourth protruding portion T4 adjacent to each other has a V shape.

Inclination angles of side surfaces of the first protruding portion T1, the second protruding portion T2, the third protruding portion T3, the fourth protruding portion T4, and the fifth protruding portion T5 are equal to each other. Therefore, in the support surface 3a2 having such a shape, a manufacturing process can be simplified. Specifically, grooves each having a V-shaped section, which are provided between the first protruding portion T1, the second protruding portion T2, the third protruding portion T3, the fourth protruding portion T4, and the fifth protruding portion T5 are continuous from one side to another side of the support surface 3a2 in the directions along the second straight line L2 and the third straight line L3. Therefore, the above number of first protruding portions T1, the plurality of second protruding portions T2, the plurality of third protruding portions T3, the plurality of fourth protruding portions T4, and the plurality of fifth protruding portions T5 can be easily formed by grinding the support surface 3a2 by moving a grindstone having a corner portion having the V-shaped section from the one side to the other side of the support surface 3a2 in the directions along the second straight line L2 and the third straight line L3.

By performing the joining process using the above-described anvil 3, the first uneven region R1 of the joint portion J of the second modification further has two fourth uneven patterns (not illustrated) and four fifth uneven patterns (not illustrated) in addition to a first uneven pattern P1, the second uneven patterns P2, and the third uneven patterns P3.

The fourth uneven patterns are located adjacent to the first uneven pattern P1 on both the outer sides of the two second uneven patterns P2 in the first direction W1. In other words, the two second uneven patterns P2 are between the two fourth uneven patterns in the first direction W1. In addition, each of the fourth uneven patterns is located at a position deviated from a range extending from each of the second uneven patterns P2 along the second direction W2 and the third direction W3 in plan view. The fourth uneven pattern has a plurality of fourth recessed portions (not illustrated).

The plurality of fourth recessed portions are arranged along one of the second direction W2 and the third direction W3 in plan view. Note that the plurality of fourth recessed portions are arranged in a matrix along the second direction W2 and the third direction W3 intersecting each other in plan view. In plan view, an area of each of the fourth recessed portions is larger than an area of each of second recessed portions U2.

In addition, a bottom of the fourth recessed portion corresponds to the shape of the upper surface of the fourth protruding portion T4 of the support surface 3a2. Specifically, the bottom of the fourth recessed portion has a planar shape and a square shape in plan view. An area of the bottom of the fourth recessed portions is larger than an area of the bottom of the fourth recessed portion.

In the second direction W2 and the third direction W3, intervals between the bottoms of the two fourth recessed portions adjacent to each other (specifically, distances between center points of the bottoms of the fourth recessed portions in plan view) are equal to each other. In addition, in each of the second direction W2 and the third direction W3, the interval between the bottom of the two fourth recessed portions adjacent to each other is larger than the interval between the bottoms B2 of the two second recessed portions U2 adjacent to each other.

The bottoms of the plurality of fourth recessed portions are located on the fourth plane S4 (see FIG. 13). Therefore, bottoms B1 of a plurality of first recessed portions U1, the bottoms B2 of the plurality of second recessed portions U2, bottoms B3 of a plurality of third recessed portions U3, the bottoms of the fourth recessed portions are located on the same plane.

Each of the fifth uneven patterns is located in a range extending from the second uneven pattern P2 along each of the second direction W2 and the third direction W3. The fifth uneven pattern is located between the second uneven pattern P2 and the fourth uneven pattern in the first direction W1. The fifth uneven pattern is adjacent to the second uneven pattern P2 in one of the second direction W2 and the third direction W3. In addition, the fifth uneven pattern is adjacent to the fourth uneven pattern in one of the second direction W2 and the third direction W3. The fifth uneven pattern has a plurality of fifth recessed portions (not illustrated).

The plurality of fifth recessed portions are arranged along at least one of the second direction W2 and the third direction W3 in plan view. In plan view, an area of each of the fifth recessed portions is larger than the area of each of the second recessed portions U2 and smaller than the area of the fourth recessed portion.

A bottom of the fifth recessed portion corresponds to the shape of the upper surface of the fifth protruding portion T5 of the support surface 3a. Specifically, the bottom of the fifth recessed portion has a planar shape and a rectangular shape in plan view. In addition, an area of the bottom of the fifth recessed portion is larger than the area of the bottom B2 of the second recessed portion U2 and smaller than the area of the bottom of the fourth recessed portion.

An interval between the bottoms of the two fifth recessed portions adjacent to each other in the second direction W2 (specifically, a distance between center points of the bottoms of the fifth recessed portions in plan view) and an interval between the bottoms of the two fifth recessed portions adjacent to each other in the third direction W3 are different from each other.

Specifically, for the fifth uneven pattern adjacent to the second uneven pattern P2 in the second direction W2, the interval between the bottoms of the two fifth recessed portions adjacent to each other in the second direction W2 is equal to the interval between the bottoms of the two fourth recessed portions adjacent to each other in the second direction W2 and the third direction W3, and the interval between the bottoms of the two fifth recessed portions adjacent to each other in the third direction W3 is equal to the interval between the bottoms B2 of the two second recessed portions U2 adjacent to each other in the second direction W2 and the third direction W3.

In addition, for the fifth uneven pattern adjacent to the second uneven pattern P2 in the third direction W3, the interval between the bottoms of the two fifth recessed portions adjacent to each other in the third direction W3 is equal to the interval between the bottoms of the two fourth recessed portions adjacent to each other in the second direction W2 and the third direction W3, and the interval between the bottoms of the two fifth recessed portions adjacent to each other in the second direction W2 is equal to the interval between the bottoms B2 of the two second recessed portions U2 adjacent to each other in the second direction W2 and the third direction W3.

The bottoms B3 of the plurality of third recessed portions U3 are located on the fourth plane S4 (see FIG. 13). Therefore, the bottoms B1 of the plurality of first recessed portions U1, the bottoms B2 of the plurality of second recessed portions U2, the bottoms B3 of the plurality of third recessed portions U3, the bottoms of the plurality of fourth recessed portions, and the bottoms of the plurality of fifth recessed portions are located on the same plane.

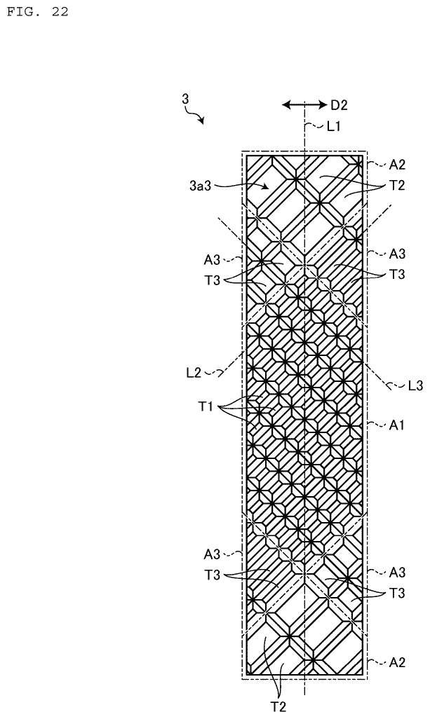

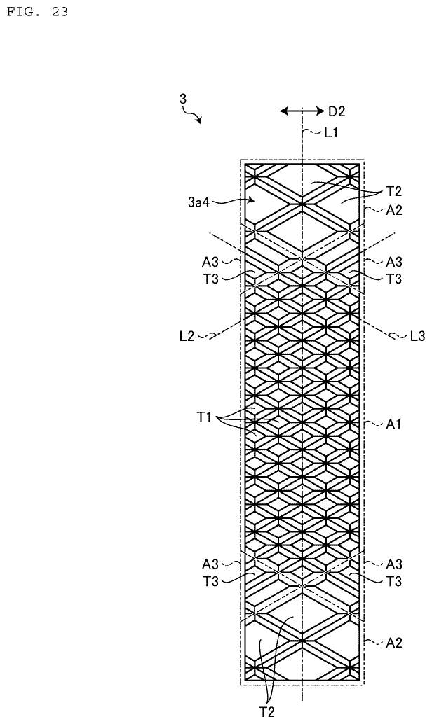

Next, with respect to a joint portion J according to a third modification of an embodiment of the present disclosure, points different from the joint portion J according to the above-described embodiment will be mainly described. FIG. 22 is a plan view of an anvil 3 used in a joining process according to the third modification of an embodiment of the present disclosure.

In a support surface 3a3 of the anvil 3 according to the third modification, each of first protruding portions T1, second protruding portions T2, and third protruding portions T3 has a quadrangular frustum shape with a rectangular lower surface and a rectangular upper surface. In addition, since the lower surface of the first protruding portion T1 has a rectangular shape, a shape of the third protruding portion T3 located in a third range A3 adjacent to a first range A1 in the second direction W2 is different from a shape of the third protruding portion T3 located in a third range A3 adjacent to a first range A1 in the third direction W3.

By performing the joining process using the above-described anvil 3, a bottom B1 of each first recessed portion U1, a bottom B2 of each second recessed portion U2, and a bottom B3 of each third recessed portion U3 included in a first uneven region R1 of the joint portion J have shapes below. That is, the bottom B1 of the first recessed portion U1 corresponding to the shape of the first protruding portion T1, the bottom B2 of the second recessed portion U2 corresponding to the shape of the second protruding portion T2, and the bottom B3 of the third recessed portion U3 corresponding to the shape of the third protruding portion T3 are each planar and rectangular in plan view.

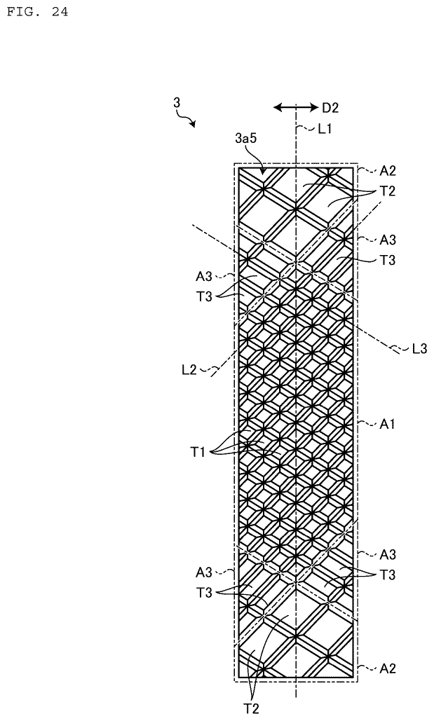

Next, with respect to a joint portion J according to a fourth modification of an embodiment of the present disclosure, points different from the joint portion J according to the above-described embodiment will be mainly described. FIG. 23 is a plan view of an anvil 3 used in a joining process according to the fourth modification of an embodiment of the present disclosure.

On a support surface 3a4 of the anvil 3 according to the fourth modification, the second straight line L2 and the third straight line L3 intersect each other without being orthogonal to each other in plan view. An angle formed by the second straight line L2 and the first straight line L1 is equal to an angle formed by the third straight line L3 and the first straight line L1, and is, for example, 60°. As a result, each of first protruding portions T1 and second protruding portions T2 has a quadrangular frustum shape with a rhombic lower surface and upper surface. In addition, each third protruding portion T3 has a quadrangular frustum shape with a parallelogram lower surface and upper surface.

By performing the joining process using the above-described anvil 3, the second direction W2 and the third direction W3 intersect each other without being orthogonal to each other in plan view.

In addition, a bottom B1 of each first recessed portion U1, a bottom B2 of each second recessed portion U2, and a bottom B3 of each third recessed portion U3 included in a first uneven region R1 of the joint portion J have shapes below. That is, the bottom B1 of the first recessed portion U1 corresponding to the shape of the first protruding portion T1 and the bottom B2 of the second recessed portion U2 corresponding to the shape of the second protruding portion T2 are each planar and rhombic in plan view. In addition, the bottom B3 of the third recessed portion U3 corresponding to the shape of the third protruding portion T3 is planar and parallelogram in plan view.

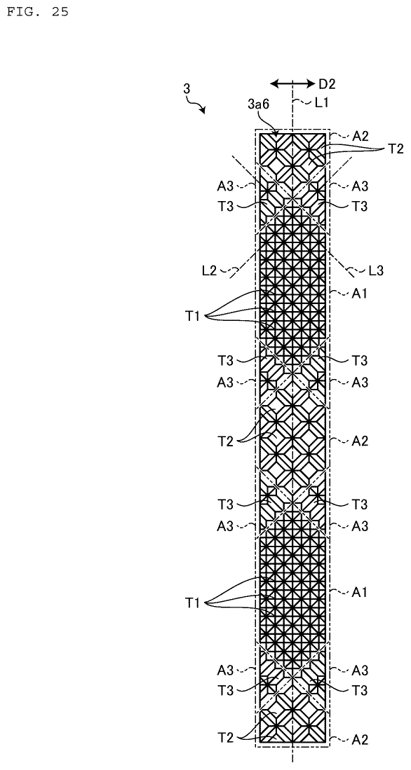

Next, with respect to a joint portion J according to a fifth modification of an embodiment of the present disclosure, points different from the joint portion J according to the above-described embodiment will be mainly described. FIG. 24 is a plan view of an anvil 3 used in a joining process according to the fifth modification of an embodiment of the present disclosure.

On a support surface 3a5 of the anvil 3 according to the fifth modification, the second straight line L2 and the third straight line L3 intersect each other without being orthogonal to each other in plan view. An angle formed by the second straight line L2 and the first straight line L1 and an angle formed by the third straight line L3 and the first straight line L1 are different to each other. The angle formed by the second straight line L2 and the first straight line L1 is, for example, 45°, and the angle formed by the third straight line L3 and the first straight line L1 is, for example, 60°. As a result, each of first protruding portions T1, second protruding portions T2, and third protruding portions T3 has a quadrangular frustum shape with a parallelogram lower surface and upper surface.

In addition, since lengths of two sides adjacent to each other on the lower surface of the first protruding portion T1 are different, a shape of the third protruding portion T3 located in a third range A3 adjacent to a first range A1 in the second direction W2 is different from a shape of the third protruding portion T3 located in a third range A3 adjacent to the first range A1 in the third direction W3.

By performing the joining process using the above-described anvil 3, the second direction W2 and the third direction W3 intersect each other without being orthogonal to each other in plan view. In addition, an angle formed by the second direction W2 and the first direction W1 and an angle formed by the third direction W3 and the first direction W1 are different from each other.

In addition, a bottom B1 of each first recessed portion U1, a bottom B2 of each second recessed portion U2, and a bottom B3 of each third recessed portion U3 included in a first uneven region R1 of the joint portion J have shapes below. That is, the bottom B1 of the first recessed portion U1 corresponding to the shape of the first protruding portion T1, the bottom B2 of the second recessed portion U2 corresponding to the shape of the second protruding portion T2, and the bottom B3 of the third recessed portion U3 corresponding to the shape of the third protruding portion T3 are each planar and parallelogram in plan view.

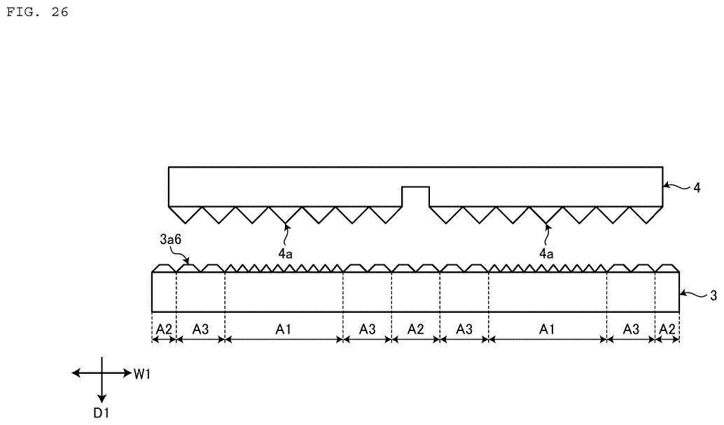

Next, with respect to a joint portion J according to a sixth modification of an embodiment of the present disclosure, points different from the joint portion J according to the first modification of the above-described embodiment will be mainly described. FIG. 25 is a plan view of an anvil 3 used in a joining process according to the sixth modification of an embodiment of the present disclosure.

A support surface 3a6 of the anvil 3 according to the sixth modification has two first ranges A1, three second ranges A2, and eight third ranges A3.

The two first ranges A1 are disposed apart from each other in the direction along the first straight line L1. The three second ranges A2 are disposed between the two first ranges A1 in the direction along the first straight line L1 and on both outer sides of the two first ranges A1 in the direction along the first straight line L1. Each of the third ranges A3 is between each of the first ranges A1 and each of the second ranges A2 in the direction along the first straight line L1. Each of the third ranges A3 is adjacent to the first range A1 in the direction along one of the second straight line L2 and the third straight line L3. In addition, the third range A3 is adjacent to the second range A2 in the direction along one of the second straight line L2 and the third straight line L3.

FIG. 26 is a side view of the anvil 3 and horn 4 used in the joining process according to the sixth modification of an embodiment of the present disclosure. A horn 4 of the sixth modification has two pressing surfaces 4a. In the joining process, each of the two pressing surfaces 4a overlaps one first range A1, the two second ranges A2 adjacent to the one first range A1, and four third ranges A3 adjacent to the one first range A1 in plan view.

By performing the joining process using the above-described anvil 3 and horn 4, two first uneven regions R1 illustrated in FIG. 11 are formed on an outer surface of a positive electrode terminal 20 in the joint portion J, and two second uneven regions R2 are formed on an outer surface of current collectors 50 in the joint portion J.

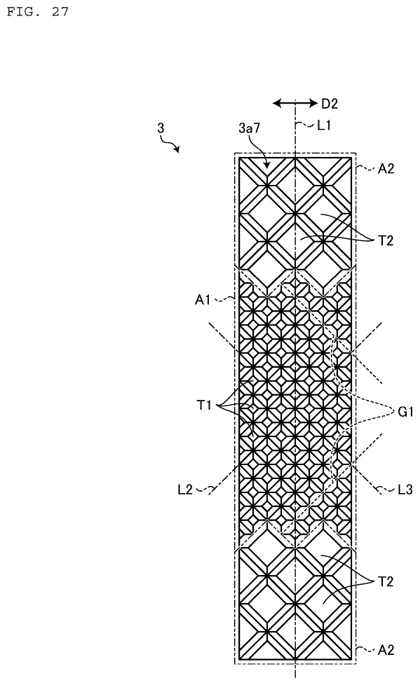

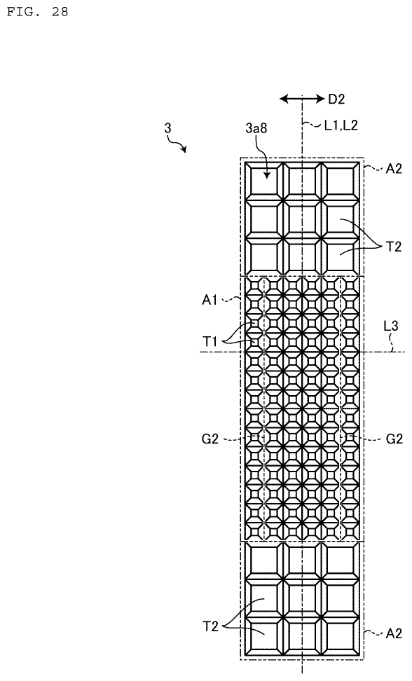

Next, with respect to a joint portion J according to a seventh modification of an embodiment of the present disclosure, points different from the joint portion J according to the above-described embodiment will be mainly described. FIG. 27 is a plan view of an anvil 3 used in a joining process according to the seventh modification of an embodiment of the present disclosure.

A support surface 3a7 of the anvil 3 according to the seventh modification does not have a third range A3. Second ranges A2 are located adjacent to a first range A1 on both outer sides of the first range A1 in the direction along the first straight line L1.

A plurality of grooves each having a V-shaped section between first protruding portions T1 and second protruding portions T2 of the seventh modification include grooves G1 (grooves each indicated by a broken line in FIG. 27) that are not continuous from one side to another side of a support surface 3a in the directions along the second straight line L2 and the third straight line L3. In this case, if a grindstone having a corner portion of a V-shaped section is moved in the directions along the second straight line L2 and the third straight line L3 from one side to the other side of the support surface 3a, the grooves G1 cannot be formed, and a working process of the support surface 3a is increased as compared with the above embodiment.

By performing the joining process using the above-described anvil 3, a first uneven region R1 does not have a third uneven pattern P3. Second uneven patterns P2 are located adjacent to a first uneven pattern P1 on both outer sides of the first uneven pattern P1 in the first direction W1.

Next, with respect to a joint portion J according to an eighth modification of an embodiment of the present disclosure, points different from the joint portion J according to the seventh modification of the above-described embodiment will be mainly described. FIG. 28 is a plan view of an anvil 3 used in a joining process according to the eighth modification of an embodiment of the present disclosure.

In a support surface 3a8 of the anvil 3 according to the eighth modification, the first straight line L1 and the second straight line L2 overlap in plan view. Similarly to the seventh modification described above, second ranges A2 are located adjacent to a first range A1 on both outer sides of the first range A1 in the direction along the first straight line L1.

A plurality of grooves each having a V-shaped section between first protruding portions T1 and second protruding portions T2 of the eighth modification include grooves G2 (each indicated by a broken line in FIG. 28) inside peripheral edges of a support surface 3a in the direction along the second straight line L2. In this case, it is difficult to form the grooves G2 with a grindstone having a corner portion having a V-shaped section, and a working direction of the support surface 3a becomes complicated as compared with the above embodiment. The grooves are formed by, for example, electrical discharge machining.

By performing the joining process using the above-described anvil 3, a first uneven region R1 does not have a third uneven pattern P3. The second direction W2 is the same direction as the first direction W1. Second uneven patterns P2 are located adjacent to a first uneven pattern P1 on both outer sides of the first uneven pattern P1 in the first direction W1.

Similarly to the joint portion J of the above embodiment, the joint portion J of each of the modifications can stabilize the joined state between the plurality of current collectors 50 and the positive electrode terminal 20 and the joined state between the plurality of current collectors 50 and the negative electrode terminal 30.

It is to be noted that the above-described embodiment is intended to facilitate understanding of the present disclosure, but not intended to construe the present disclosure in any limited way. The present disclosure may be modified or improved without departing from the spirit of the present disclosure, and the present disclosure includes equivalents of the present disclosure.

For example, the laminated body 10 may be a wound type. In addition, the laminated body 10 may configure an all solid battery. In this case, the laminated body 10 has a positive electrode and a negative electrode, and a solid electrolyte is accommodated in the accommodating portion 41.

In addition, obviously, the shape of the support surface 3a is not limited to a rectangular shape in plan view, and may be, for example, a square shape or a circular shape in plan view.

In addition, the plurality of first protruding portions T1, the plurality of second protruding portions T2, the plurality of third protruding portions T3, the plurality of fourth protruding portions T4, and the plurality of fifth protruding portions T5 may be disposed in a state where the lower surfaces are separated from each other.

Further, the plurality of sixth protruding portions T6 of the pressing surface 4a may not have the eighth protruding portions T8 and may be configured by the seventh protruding portions T7. In this case, each of the bottoms of the plurality of sixth recessed portions U6 included in the second uneven region R2 corresponds to the shape of each of the seventh protruding portions T7 and are located on the same plane.

In addition, the first uneven region R1 and the second uneven region R2 may not extend along the first direction W1, and may have equal lengths in two directions orthogonal to each other in plan view, and may have, for example, a square shape, a circular shape, or the like. In this case, the pressing surface 4a of the horn 4 has, for example, a square shape or a circular shape in plan view.

It is to be noted that the present disclosure m the following configurations and combinations thereof according to an embodiment.
(1)

A secondary battery including:
a laminated body in which a plurality of electrodes are laminated;
a plurality of current collectors electrically connected to the plurality of electrodes; and
a terminal joined to the plurality of current collectors,
wherein
an outer surface of the terminal at a joint portion between the plurality of current collectors and the terminal has a first uneven region having an uneven shape,
the first uneven region has:
   a first uneven pattern having a plurality of first recessed portions; and
   two second uneven patterns each having a plurality of second recessed portions each having a larger area than an area of each of the first recessed portions in plan view of the outer surface of the terminal, and
the first uneven pattern is located between the two second uneven patterns in the plan view.
(2)

The secondary battery according to (1), wherein
the first uneven region extends along a first direction in the plan view, and
the first uneven pattern is located between the two second uneven patterns in the first direction.
(3)

The secondary battery according to (1) or (2), wherein the plurality of first recessed portions are arranged in a matrix along a second direction and a third direction intersecting each other in the plan view.
(4)

The secondary battery according to (3), wherein the plurality of second recessed portions are arranged along one of the second direction and the third direction in the plan view.
(5)

The secondary battery according to (3) or (4), wherein
the first uneven region further has a third uneven pattern having a plurality of third recessed portions each having an area in plan view larger than the area of each of the first recessed portions and smaller than the area of each of the second recessed portions,
the third uneven pattern is adjacent to the first uneven pattern in one of the second direction and the third direction, and
the second uneven patterns are located at positions deviated from ranges extending from the first uneven pattern along the second direction and the third direction in the plan view.
(6)

The secondary battery according to any one of (1) to (5), wherein
an outer surface of the current collectors at the joint portion has a second uneven region having an uneven shape, and
a depth of the first uneven region is smaller than a depth of the second uneven region.
(7)

The secondary battery according to any one of (1) to (6), wherein
the plurality of electrodes has a positive electrode and a negative electrode, and
the laminated body has a laminated structure in which the positive electrode and the negative electrode are laminated with a separator interposed therebetween.

### DESCRIPTION OF REFERENCE SYMBOLS

1: Secondary battery
10: Laminated body
11: Positive electrode (electrode)
12: Negative electrode (electrode)
13: Separator
20: Positive electrode terminal (terminal)
30: Negative electrode terminal (terminal)
50: Current collector
B1: Bottom of first recessed portion
B2: Bottom of second recessed portion
B3: Bottom of third recessed portion
J: Joint portion
P1: First uneven pattern
P2: Second uneven pattern
P3: Third uneven pattern
R1: First uneven region
R2: Second uneven region
T1: First protruding portion
U1: First recessed portion
U2: Second recessed portion
U3: Third recessed portion
W1: First direction
W2: Second direction
W3: Third direction

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a laminated body in which a plurality of electrodes are laminated;
a plurality of current collectors electrically connected to the plurality of electrodes; and
a terminal joined to the plurality of current collectors,
wherein
an outer surface of the terminal at a joint portion between the plurality of current collectors and the terminal has a first uneven region having an uneven shape,
the first uneven region has:
a first uneven pattern having a plurality of first recessed portions; and
two second uneven patterns each having a plurality of second recessed portions each having a larger area than an area of each of the first recessed portions in plan view of the outer surface of the terminal, and
the first uneven pattern is located between the two second uneven patterns in the plan view.

2. The secondary battery according to claim 1, wherein
the first uneven region extends along a first direction in the plan view, and
the first uneven pattern is located between the two second uneven patterns in the first direction.

3. The secondary battery according to claim 1, wherein the plurality of first recessed portions are arranged in a matrix along a second direction and a third direction intersecting each other in the plan view.

4. The secondary battery according to claim 3, wherein the plurality of second recessed portions are arranged along one of the second direction and the third direction in the plan view.

5. The secondary battery according to claim 3, wherein
the first uneven region further has a third uneven pattern having a plurality of third recessed portions each having an area in plan view larger than the area of each of the first recessed portions and smaller than the area of each of the second recessed portions,
the third uneven pattern is adjacent to the first uneven pattern in one of the second direction and the third direction, and
the second uneven patterns are located at positions deviated from ranges extending from the first uneven pattern along the second direction and the third direction in the plan view.

6. The secondary battery according to claim 1, wherein
an outer surface of the current collectors at the joint portion has a second uneven region having an uneven shape, and
a depth of the first uneven region is smaller than a depth of the second uneven region.

7. The secondary battery according to claim 1, wherein
the plurality of electrodes has a positive electrode and a negative electrode, and
the laminated body has a laminated structure in which the positive electrode and the negative electrode are laminated with a separator interposed therebetween.
